(19) United States
(12) Patent Application Publication
(10) Pub. No.: US 2010/0131760 A1
(43) Pub. Date: May 27, 2010

(54) CONTENT USING SYSTEM AND CONTENT USING METHOD

(75) Inventor: Naotake Fujita, Tokyo (JP)

Correspondence Address: Mr. Jackson Chen, 6535 N. STATE HWY 161, IRVING, TX, 75039, US

(73) Assignee: NEC CORPORATON, TOKYO (JP)

(21) Appl. No.: 12/593,437

(22) PCT Filed: Apr. 8, 2008
(86) PCT No.: PCT/JP2008/056941

§ 371 Date: Dec. 7, 2009

(30) Foreign Application Priority Data
Apr. 11, 2007 (JP) 2007-104186

(51) Int. Cl. H04L 9/32

(52) U.S. Cl. 713/168

(57) ABSTRACT

For an audio-visual terminal that reproduces content, anonymity of a user is ensured while enabling reproduction of the content. A content using system of the present invention includes a communication terminal, an audio-visual terminal and a license server. The communication terminal generates an electronic ticket by providing a group sign to license information obtained from the license server. The audio-visual terminal, after verifying the group sign of the electronic ticket obtained from the communication terminal, transmits the electronic ticket to the license server. The license server judges whether or not the electronic ticket is usable, which is transmitted from the audio-visual terminal and assigns a license of the content to the audio-visual terminal when the electronic ticket is judged to be usable. The audio-visual terminal decrypts the content which is encrypted, by using a decryption key obtained based on the license, and reproduces the content.

### TECHNICAL FIELD

The present invention relates to a content using system and a content using method, and more particularly relates to a content using system and a content using method which use an encrypted digital content. By the way, this application is based upon and claims the benefit of priority from Japanese Patent Application No. 2007-104186, and the disclosure of Japanese Patent Application No. 2007-104186 is incorporated herein in its entirely by reference.

### BACKGROUND ART

In recent years, a service and a system are spread in which an STB (Set Top Box), a computer apparatus or a mobile communication terminal obtains, reproduces and uses digital content (hereafter, referred to as content), such as video, music and the like which are delivered by a content sever. Content delivered in such a system is usually encrypted such that the content can be reproduced to be viewed or listened by only a terminal having a license to view or listen to it. DRM (Digital Rights Management) is a technique that allows only a person having such license to view or listen to it.

According to the DRM, content which is encrypted (hereafter, referred to as encrypted content) is provided, and a decryption key for decrypting the encrypted content is provided to a terminal having a license. The license is a right to reproduce or copy the content. Information for limiting a number of reproduction or copy and a usable period is provided to the terminal to which the license is assigned. As products in which the DRM is used, for example, there are [Windows Media Technology (registered mark)] and [Media Commerce Suite].

Also, for example, as fcr a service (for example, a service for providing audition of music) in which a number of access is limited, [Isamu Teranishi, Jun Furukawa, and Kazue Sako, “k-times anonymous Authentication,” ASIACRYPT 2004, LNCS 3329, pp. 308-322. Springer-Verlag, 2004] describes a technique in which the number of access is set for each user and the user is authenticated while ensuring anonymity.

On the other hand, Japanese Laid Open Patent Application (JP-P 2004-280851A) describes a content providing method that provides content as a consideration for an electronic value transmitted from a mobile terminal. Also, Japanese Laid Open Patent Application (JP-P 2004-103013A) describes a conventional technique with regard to a buying, presenting and using method of an electronic merchandise coupon by using a mobile communication terminal or the like. Moreover, Japanese Laid Open Patent Application (JP-P 2005-327113A) describes a conventional technique in which content protected in copyright is provided in response to a request from a user terminal.

Also, Japanese Laid Open Patent Application (JP-P 2000-306005A) describes a system which uses a mobile terminal to exhibit a redemption certification or reception certification issued by a server to a fixed terminal and to obtain, from the fixed terminal, an electronic ticket that can be exchanged with an electronic value (content). Here, the fixed terminal transmits the exhibited redemption certification or reception certification to the server such that the server judges whether or not it is usable. If it is usable, the fixed terminal obtains the electronic ticket from the server and transfers the electronic ticket to the mobile terminal. Also, the redemption certification or the reception certification includes information with regard to an expiration date and the content, and is signed by the server or a provider of the content. For this reason, only when the redemption certification or reception certification is verified to be usable, a user can obtain the electronic ticket that can be exchanged with the content. However, in the obtainment of the electronic ticket, there is a risk that information with regard to the user (mobile terminal) is leaked to the fixed terminal.

### DISCLOSURE OF INVENTION

The present invention proposes a method to ensure, for an audio-visual terminal that reproduces content, anonymity of a user while enabling reproduction of the content. Also, the present invention proposes a method to unitarily manage information with regard to a user using content. Moreover, the present invention proposes a method to trace an issuer of an electronic ticket for providing a right to use content.

A content using system according to the present invention includes a communication terminal, an audio-visual terminal and a license server. The license server transmits license information including a using condition of content to the communication terminal. The communication terminal issues an electronic ticket including the license information to which a group sign is provided. After verifying the group sign of the electronic ticket obtained from the communication terminal, the audio-visual terminal transmits the electronic ticket to the license server. After verifying the group sign of the electronic ticket transmitted from the audio-visual terminal, the license server judges based on the using condition whether or not the electronic ticket is usable. When the electronic ticket is judged to be usable, the license server assigns a license of the content to the audio-visual terminal. The audio-visual terminal decrypts the content which is encrypted by using a decryption key obtained based on the license and reproduces the content.

In this way, the group sign is provided to the electronic ticket according to the present invention. Thus, it is possible to certify a validity of the electronic ticket while concealing information with regard to the communication terminal from the audio-visual terminal. Also, the audio-visual terminal can make the license server, which assigns the license, to verify whether or not the electronic ticket is usable.

The license server is preferred to include a group database which manages a group and the communication terminal such that they are correlated with each other. The communication terminal registered in the group database obtains a member key and member certification information specific to the communication terminal. The member certification information is generated by using a group public key. The communication terminal generates the group sign by using the member key and the member certification information. Also, the audio-visual terminal verifies the group sign by using the group public key. In the content using system according to the present invention, the group is unitarily managed by the license server and only the terminal group-registered in the license server can generate the electronic ticket.

The license server is preferred to further include a subscriber information database which stores information with regard to a user of the communication terminal and a terminal ID of the communication terminal such that they are correlated with each other. In this case, the license server stores the terminal ID and the group in the group database such that they are correlated with each other. Consequently, the communication terminal that can provide the group sign and the information with regard to the user of the communication terminal are linked to each other. Thus, the information with regard to the user which uses the electronic ticket can be obtained.

The electronic ticket is preferred to include: the license information; ticket information including information specifying content which can be used based on the electronic ticket; and the group sign provided to the license information and the ticket information. In this case, the electronic ticket serves as an electronic certificate for using the content specified by the communication terminal.

The license server is preferred to further include a license database which registers a license ID assigned to the license information. When the license database does not register a license ID included in the electronic ticket transmitted from the audio-visual terminal, the license server does not assign the license to the audio-visual terminal. Thus, this can prevent an illegally-generated electronic ticket from being used.

The license information includes: content information including information with regard to one or a plurality of contents included in a product; the using condition; and a digital sign which is provided to the content information and the using condition based on a license server secret key possessed by only the license server. The using condition is preferred to include a reproducing condition of the content for the audio-visual terminal; and an issuing condition of the electronic ticket for the communication terminal. Here, the issuing condition is preferred to include information indicating a period in which or a number of times at which the electronic ticket can be issued based on the license information. Also, the reproducing condition is preferred to include information indicating a number of times at which the audio-visual terminal can reproduce content based on the electronic ticket.

Also, the content information is preferred to include reproducible periods of one or a plurality of contents included in the product. In this case, the license server refers to the reproducible periods included in the electronic ticket transmitted from the audio-visual terminal to judge whether or not the electronic ticket is usable.

According to the present invention, for an audio-visual terminal that reproduces content, it is possible to ensure anonymity of a user while enabling reproduction of the content. Also, it is possible to unitarily manage information with regard to a user using content. Moreover, it is possible to trace an issuer of an electronic ticket for providing a right to use content.

### BRIEF DESCRIPTION OF DRAWINGS

FIG. 1 shows a configuration in an exemplary embodiment of a content using system according to the present invention;

FIG. 2 is a block diagram showing a schema of operation of the content using system according to the present invention;

FIG. 3 shows functions of a communication terminal program according to the present invention;

FIG. 4 shows functions of an audio-visual terminal program according to the present invention;

FIG. 5 shows a configuration of a storage device of a license server according to the present invention;

FIG. 6 shows functions of a license server program according to the present invention;

FIG. 7 shows one example of a configuration of a license database according to the present invention;

FIG. 8 shows one example of a configuration of a subscriber information database according to the present invention;

FIG. 9 is a sequence diagram showing an operation of a group registration process in the content using system according to the present invention;

FIG. 10 shows kinds of keys possessed by respective elements of the content using system according to the present invention;

FIG. 11 is a sequence diagram showing an operation from an obtainment of license information to an issue of a ticket in the content using system according to the present invention;

FIG. 12 shows a configuration of content information according to the present invention;

FIG. 13 shows a configuration of license information according to the present invention;

FIG. 14 shows a configuration of a ticket according to the present invention;

FIG. 15 is a sequence diagram showing an operation of a ticket verification process in the content using system according to the present invention; and

FIG. 16 is a sequence diagram showing one example of an operation from a delivery of content to a reproduction of the content in the content using system according to the present invention.

### BEST MODE FOR CARRYING OUT THE INVENTION

Exemplary embodiments of a content using system according to the present invention will be described below with reference to the attached drawings. The same or similar reference symbols in the drawings indicate the same, similar or equivalent elements.

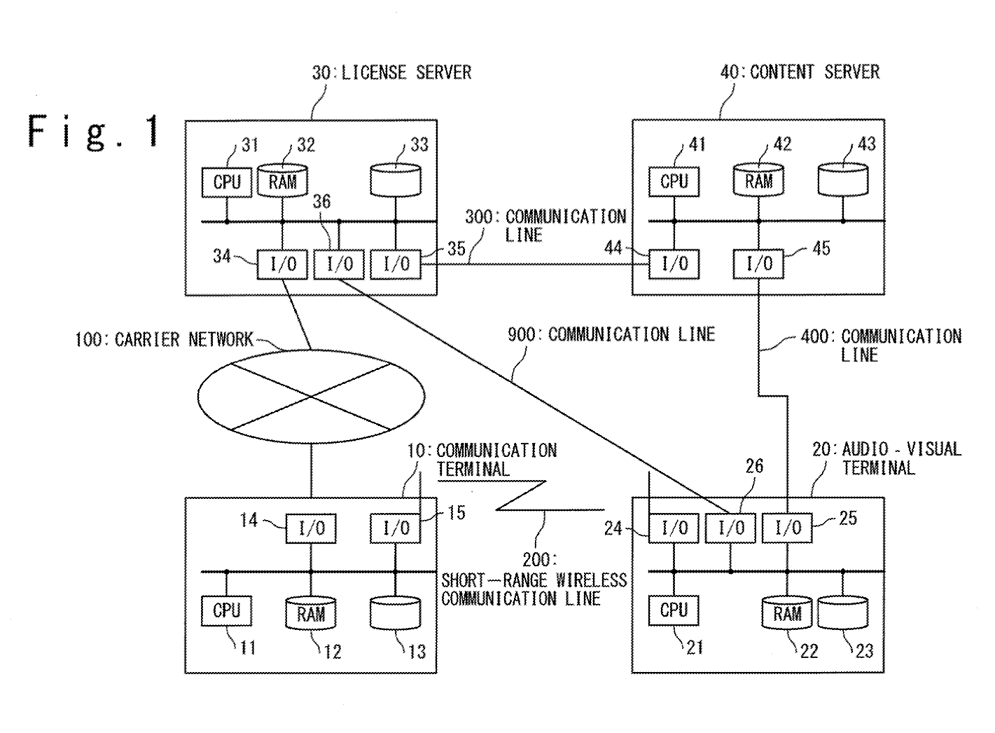

An exemplary embodiment of a content using system according to the present invention will be described below with reference to FIGS. 1 to 16. The present exemplary embodiment is described by exemplifying a system in which video content provided from a content server is reproduced by an STB (Set to Box).

(Configuration)

A configuration of a first exemplary embodiment of the content using system according to the present invention will be described with reference to FIGS. 1 to 8. FIG. 1 shows the configuration of the content using system according to the present invention.

With reference to FIG. 1, the content using system includes a communication terminal 10, an audio-visual terminal 20, a license server 30 and a content server 40. The communication terminal 10, the audio-visual terminal 20, the license server 30 and the content server 40 are connected to a carrier network 100. However, actually, the communication terminal 10, the audio-visual terminal 20, the license server 30 and the content server 40 are not limited to physical equipments but may be virtual machine (VM) environments installed in computers.

The communication terminal 10 is connected through the carrier network 100 to the license server 30 and connected through a short-range wireless communication line 200 to the audio-visual terminal 20. The audio-visual terminal 20 is connected through a communication line 900 to the license server 30 and connected through a communication line 400 to the content server 40. The license server 30 is connected through a communication line 300 to the content server 40. The respective elements of the content using system according to the present invention are not required to be always connected, and they are preferred to be connected as necessary.

The carrier network 100 is a communication network, such as a mobile telephone communication network or a fixed telephone communication network, which is managed by a communication common carrier or an enterprise (hereafter, referred to as a carrier).

The license server 30 is preferred to be a computer apparatus managed by the carrier.

The communication terminal 10 is capable of communicating with another communication terminal 10 (not shown) by using the carrier network 100.

The audio-visual terminal 20 is a video viewing apparatus exemplified as an STB. In the present exemplary embodiment, the audio-visual terminal 20 is described by using the STB as an example. However, the audio-visual terminal 20 is not limited to the STB but may be a music player, a monitor, a PDA, a mobile telephone with a displaying function, a computer apparatus, storage or the like.

The content server 40 is a computer apparatus that delivers or broadcasts content as products.

The content in the present exemplary embodiment is video data. However, the content is not limited to the video data but may be music data, image data or text data.

Although not shown, the content using system according to the present invention is preferred to include a plurality of communication terminals 10, audio-visual terminals 20 and content servers 40.

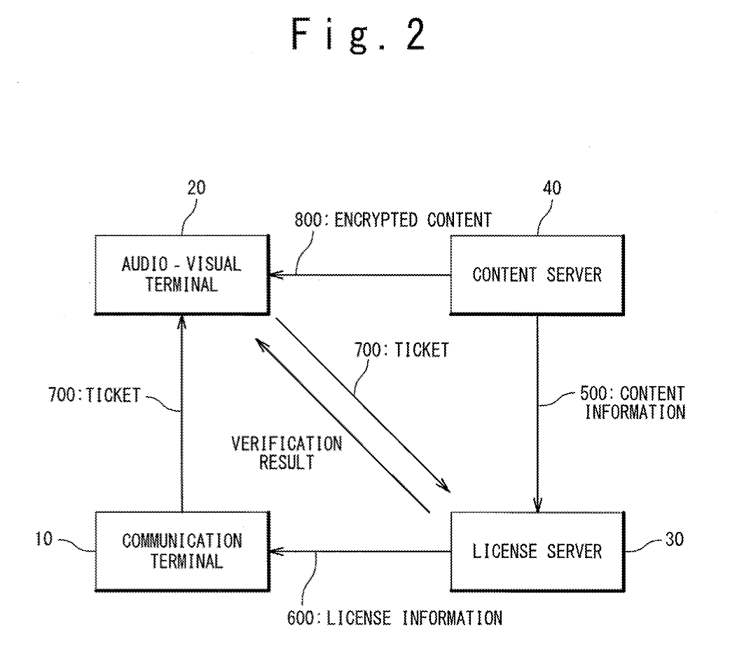

The schema of the content using system according to the present invention will be described below with reference to FIG. 2.

The content server 40 registers to the license server 30, information (content information 500) concerning to products (including one or a plurality of contents) which are provided by the content server 40.

The license server 30 transmits a right to use a product purchased by a user of the communication terminal 10, as license information 600 to the communication terminal 10.

The communication terminal 10 authorizes the license information by providing a group sign thereto to generate an electronic ticket (hereafter, referred to as a ticket 700) and transmits the ticket 700 to the audio-visual terminal 20.

The audio-visual terminal 20 verifies the group sign of the ticket 700 to check that there is no modification. After that, in order to verify whether or not the ticket 700 is usable, the audio-visual terminal 20 transmits the ticket 700 to the license server 30.

The license server 30 verifies whether or not the ticket 700 is usable based on a using condition and license ID which are included in the ticket 700, and transmits the verification result to the audio-visual terminal 20. At this time, if the ticket 700 is usable, the license server 30 assigns a license of the content specified by the ticket 700 to the audio-visual terminal 20 which has requested the verification.

The audio-visual terminal 20 to which the license is assigned, based on the using condition included in the ticket, obtains an encrypted content 800 from the content server 40 and reproduces the obtained encrypted content 800.

The configuration of the content using system according to the exemplary embodiment will be described below in detail.

The communication terminal 10 is a communication terminal (for example, a mobile communication terminal or PDA) which is capable of being connected to the carrier network 100 by using an I/O interface 14.

As shown in FIG. 1, the communication terminal 10 includes a CPU 11, a RAM 12, a storage device 13, the I/O interface 14 and an I/O interface 15. The CPU 11, the RAM 12, the storage device 13, the I/O interface 14 and the I/O interface 15 are connected to each other through a bus. The CPU 11 controls the I/O interface 14 and the I/O interface 15 to control transmission and reception of various data.

The I/O interface 14 is connected through a wireless line or wired line to the carrier network 100 and controls transmission and reception of data between the communication terminal 10 and the carrier network 100. The I/O interface 14 is preferred to be capable of being connected through the carrier network 100 to a global network such as the Internet or the like. In this case, the communication terminal 10 communicates with the license server 30 through the global network.

Also, the I/O interface 15 is capable of being connected through the short-range wireless communication line 200 to the audio-visual terminal 20. The I/O interface 15 controls transmission and reception of data to and from the audio-visual terminal 20 connected through the short-range wireless communication line 200 to the I/O interface 15.

The communication terminal 10 transmits the ticket 700 through the short-range wireless communication line 200 to the audio-visual terminal 20. Here, a communication is preferable that uses a communication protocol such as HTTPS (Hypertext Transfer Protocol over Transport Layer Security), which enables a confidential communication.

The short-range wireless communication line 200 is preferred to be an infrared communication line, Bluetooth (registered trademark), NFC (Near Field Communication) or a communication line based on visible light communication, for example. By the way, the short-range wireless communication line 200 is required only to enable transmission and reception of data between the communication terminal 10 and the audio-visual terminal 20. Thus, the short-range wireless communication line 200 is not limited to a wireless line but may be a wired line. Also, data transmitted or received through the short-range wireless communication line 200 may be transmitted or received through the carrier network 100.

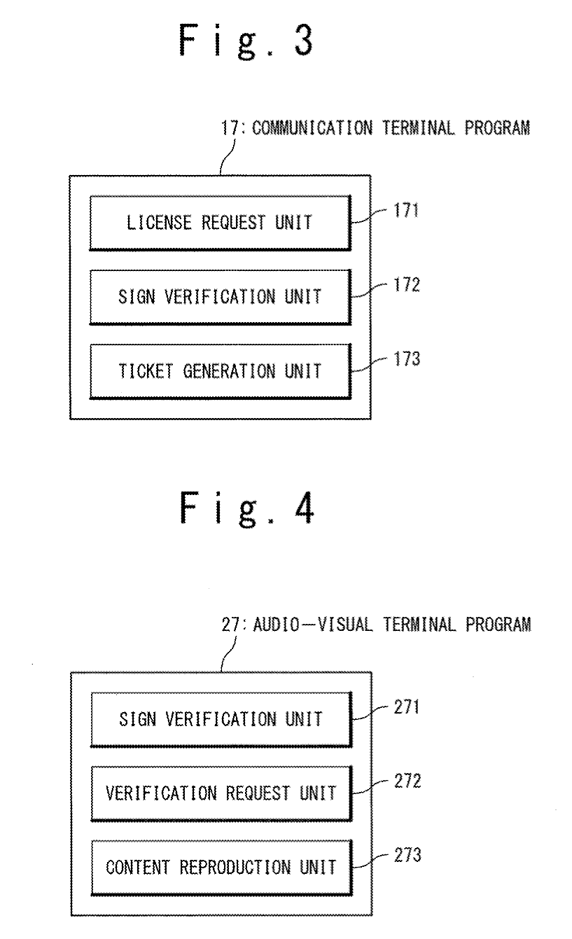

Also, the CPU 11 executes a communication terminal program 17 stored in the storage device 13 to implement respective functions shown in FIG. 3.

With reference to FIG. 3, the communication terminal program 17 includes a license request unit 171, a sign verification unit 172 and a ticket generation unit 173. In detail, the CPU 11 executes the communication terminal program 17 temporarily stored in the RAM 12 to implement the respective functions of the license request unit 171, the sign verification unit 172 and the ticket generation unit 173. That is, a configuration example of the communication terminal program 17 shown in FIG. 3 indicates a configuration example of the CPU 11 when the communication terminal program 17 is executed.

The license request unit 171 requests the license server 30 for group subscription and issue of the license information 600 of a desired content.

In the content using system according to the present invention, the license information 600 is not issued to the communication terminal 10 that is not group-registered in the license server 30. Thus, the communication terminal 10 is required to be group-registered in the license server 30 prior to the reception of the issue of the license information 600.

The sign verification unit 172 uses a license server public key 93 to verify a license server sign 602 provided to the license information 600. Also, the sign verification unit 172 uses a content server public key 96 to verify a content server sign 602 provided to the content information 500.

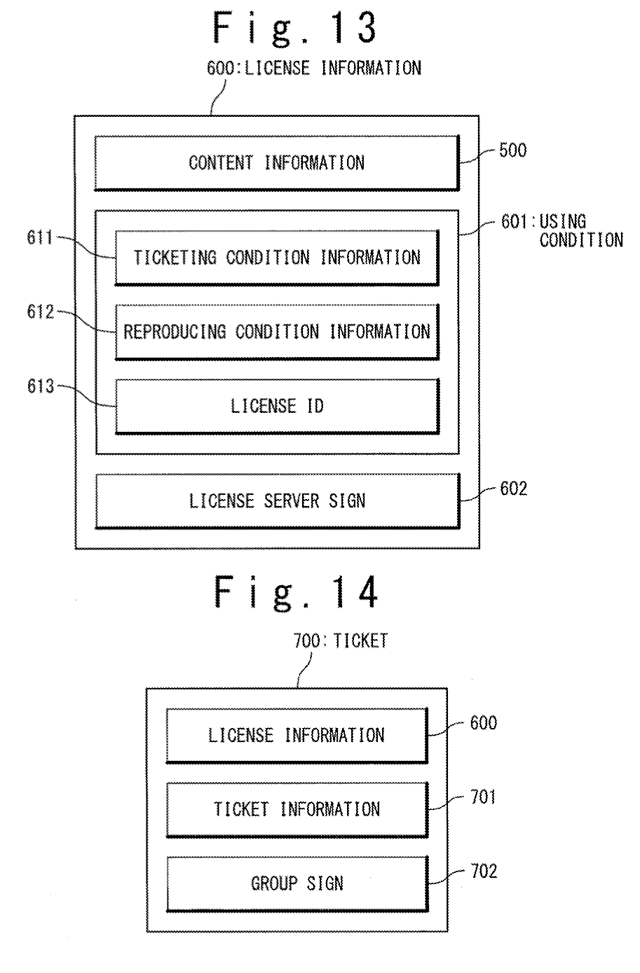

The ticket generation unit 173 authorizes the license information 600 issued by the license server 30 to generate the ticket 700. With reference to FIG. 13, the ticket generation unit 173 specifies content as a target of reproduction and a method to obtain the content as ticket information 701 for the license 500 and provides a group sign 702 to the license 500 by using a member key 94 generated at the group-registration to generate the ticket 700.

The ticket information 701 includes, for example, a name, an identifier, a resolution, a method to obtain (method to download) from the content server 40 and the like of content reproduced by the audio-visual terminal 20.

As mentioned above, by executing the communication terminal program 17, the communication terminal 10 obtains the license information 600 from the license server 30 and generates the ticket 700 for reproducing the purchased content.

Here, the detail of the group sign 702 provided when the ticket 700 is generated is described. For example, the present invention uses a group sign method described in [G. Ateniese, J. Camenisch, M. Joye and G. Tsudik, “A Practical and Provably Secure Coalition-Resistant Group Signature Scheme”, In advances in Cryptology CRYPTO 2000, LNCS 1880, p 255-270, Springer-Verlag, 2000.].

Since being group-registered in the license server 40, the communication terminal 10 obtains the member key 94 and member certification information 95 which are specific to the communication terminal 10. In detail, the communication terminal 10 generates a terminal public key, a terminal secret key and sign partial information from random number and a group public key 91 and transmits the terminal public key and the sign partial information to the license server 30.

The license server 30 generates a digital sign by using a group secret key for sign, 90A and the sign partial information received from the communication terminal 10 and outputs the digital sign as the member certification information 95.

Since the communication terminal 10 holds the member certification information 95 signed by the license server 30, the registration in the group is insured.

On the other hand, the license server 30 transmits partial information for generating the member key 94 specific to the terminal to the communication terminal 10.

The communication terminal 10 generates the member key 94 specific to the communication terminal 10 by using random number generated at the group-registration, the partial information from the license server 30 and the terminal secret key corresponding to the terminal public key.

As mentioned above, the communication terminal 10 group-registered in the license server 4U can obtain the member key 94 specific to the terminal and the member certification information 95.

The communication terminal 10 provides the group sign to an electronic certificate by using the member key 94 and the member certification information 95. In detail, the ticket generation unit 173 of the communication terminal 10 generates conversion data from the member key 94, random number generated by a random number generator (not shown) and the member certification information 95. The ticket generation unit 173 generates the group sign 702 by using the conversion data and the messages (the content information 500, the license information 600 and the ticket information 701). By the way, the group sign according to the present invention is preferred to be a group sign which has a high processing speed and uses a bilinear property of Weil pairing or Tate pairing on an elliptic curve.

The group sign can be verified by using the group public key 91 which is common in the group. Thus, the audio-visual terminal 20 which verifies the sign cannot specify the communication terminal 10 which has provided the group sign.

However, the license server 30 can extract the terminal public key of the communication terminal 10 which has provided the sign from the group sign by using a group secret key for encryption, 90B. Meanwhile, at the group-registration, the license server 30 records a terminal ID and the terminal public key of the communication terminal 10, the digital sign provided to the member certification information 95 and the like such that they are correlated with each other.

For this reason, by referring to the terminal ID corresponding to the terminal public key extracted from the group sign, it is possible to specify the communication terminal 10 which has generated the ticket 700. Also, as described later, the terminal ID is correlated with subscriber information of the user having the communication terminal 10. Thus, the license server 30 can specify the user who has issued the ticket 700.

The audio-visual terminal 20 is a computer apparatus (for example, STB, a mobile communication terminal, a computer, storage or the like) capable of being connected to the content server 40 through an I/O interface 25.

As shown in FIG. 1, the audio-visual terminal 20 includes a CPU 21, a RAM 22, a storage device 23, an I/O interface 24, the I/O interface 25 and an I/O interface 26. The CPU 21, the RAM 22, the storage device 23, the I/O interface 24, the I/O interface 25 and the I/O interface 26 are connected to each other through a bus. The CPU 21 controls the I/O interface 24, the I/O interface 25, and the I/O interface 26 to control transmission and reception of various data.

The I/O interface 24 is capable of being connected through, the short-range wireless communication line 200 to the communication terminal 10. The audio-visual terminal 20 obtains the ticket 700 from the communication terminal 10 through the short-range wireless communication line 200. Here, a communication is preferable that uses a communication protocol (for example, HTTPS) which enables a confidential communication.

Also, the I/O interface 25 is connected through a wireless line or a wired line to the communication line 400, and controls transmission and reception of data between the audio-visual terminal 20 and the content server 40. Here, the communication line 400 is preferred to be a global network such as the Internet or a broadcast line. However, the communication line 400 may be a local network, a communication line using a private line, or a communication line through the carrier network 100.

Moreover, the I/O interface 26 is capable of being connected through a communication line 900 to the license server 30. The audio-visual terminal 20 transmits the ticket 700 through the communication line 90 to the license server 30. The communication line 900 is preferred to be a global network such as the Internet. However, the communication line 900 may be a local network, a communication line using a private line, or a communication line through the carrier network 100.

Also, the CPU 21 executes an audio-visual terminal program 27 stored in the storage device 23 to implement various functions shown in FIG. 4.

With reference to FIG. 4, the audio-visual terminal program 27 includes a sign verification unit 271, a verification request unit 272 and a content reproduction unit 273. In detail, the CPU 21 executes the audio-visual terminal program 27 temporarily stored in the RAM 22 to implement the respective functions of the sign verification unit 271, the verification request unit 272 and the content reproduction unit 273. That is, a configuration example of the audio-visual terminal program 27 shown in FIG. 4 indicates a configuration example of the CPU 21 when the audio-visual terminal program 27 is executed.

The sign verification unit 271 verifies the group sign 702, the license server sign 602 and a content server sign 502 which are provided to the ticket 700 obtained from the communication terminal 10 by using the group public key 91, license server public key 93 and content server public key 96 which are obtained in advance to judge a validity of the ticket 700 and the presence or absence of modifications in the ticket 700. In order to examine whether or not the obtained ticket 700 is usable, the verification request unit 272 transmits the ticket 700 to the license server 30.

Also, the verification request unit 272 obtains the verification result from the license server 30. When the ticket 700 is judged to be usable, the verification request unit 272 obtains by using some method a decryption key for decrypting the encrypted content 800 which is obtained from the content server 40. By the way, examples of a method to obtain the decryption key will be described later.

The content reproduction unit 273 reproduces the encrypted content 800 obtained from the content server 40 by using a method based on the ticket information 701 included in the ticket 700 to output the encrypted content 800 to a not-shown output device (for example, a monitor (display device)). In detail, the content reproduction unit 273 refers to the ticket information 701 included in the ticket 700 to determine the matter of the reproduction target content, an obtaining method (download method) thereof and the like. The content reproduction unit 273 obtains the reproduction target content (encrypted content 800) from the content server 40 by using the determined obtaining method. The content reproduction unit 273 decrypts the encrypted content 800 by using the decryption key obtained by the verification request unit 272 to reproduce the encrypted content 800.

The license server 30 is a computer apparatus capable of being connected to the carrier network 100 through an I/O interface 34.

As shown in FIG. 1, the license server 30 includes a CPU 31, a RAM 32, a storage device 33, the I/O interface 34, an I/O interface 35 and an I/O interface 36. The CPU 31, the RAM 32, the storage device 33, the I/O interface 34, the I/O interface 35 and the I/O interface 36 are connected to each other through a bus. The CPU 31 controls the I/O interface 34, the I/O interface 35, and the I/O interface 36 to control transmission and reception of various data.

The I/O interface 34 is preferred to be capable of being connected through the carrier network 100 to a global network such as the Internet or the like. In this case, the license server 30 communicates with the communication terminal 10 through the global network.

Also, the I/O interface 35 is connected through the communication line 300 to the content server 40. In detail, the I/O interface 35 is connected through a communication line to the carrier network 100 and controls transmission and reception of data between the license server 30 and the carrier network 100. Consequently, the I/O interface 35 controls transmission and reception of data to and from the content server 40. Here, the communication line 300 is preferred to be a local network or a communication line which uses a private line. However, the communication line 400 may be a global network such as the Internet or a communication line through carrier network 100.

Moreover, the I/O interface 36 is connected through the communication line 900 to the audio-visual terminal 20. The I/O interface 36 controls transmission and reception of data to and from the audio-visual terminal 20.

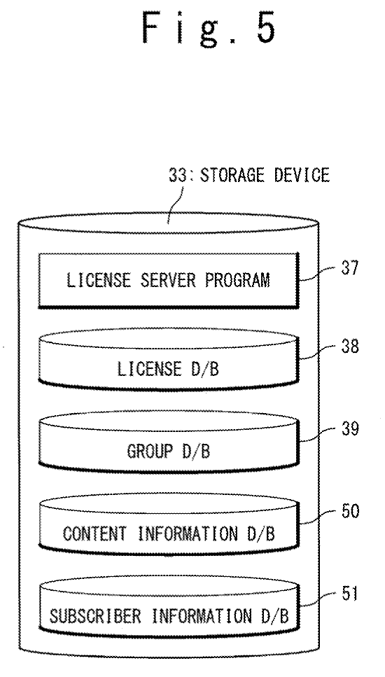

With reference to FIG. 5, the storage device 33 includes a license server program 37, a license database (license D/B) 38, a group database (group D/B) 39, a content information database (content information D/B) 50 and a subscriber information database (subscriber information D/B) 51.

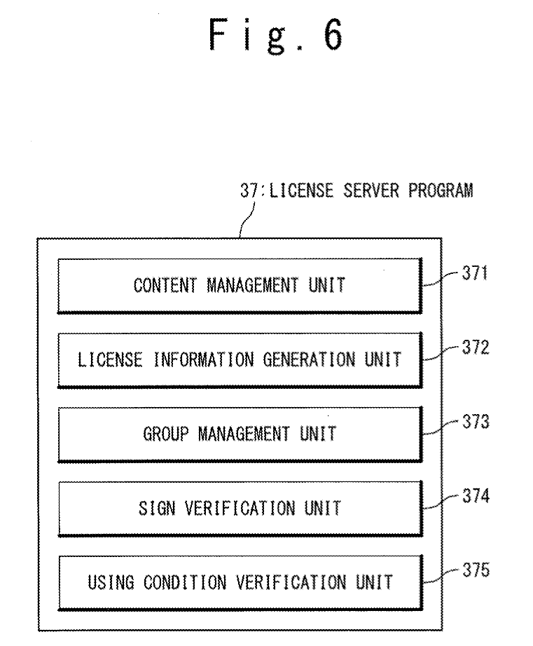

The CPU 31 executes the license server program 37 stored in the storage device 33 to implement various functions shown in FIG. 6.

With reference to FIG. 6, the license server program 37 includes a content management unit 371, a license information generation unit 372, a group management unit 373, a sign verification unit 374 and a using condition verification unit 375. In detail, the CPU 31 executes the license server program 37 temporarily stored in the RAM 32 to implement the various functions of the content management unit 371, the license information generation unit 372, the group management unit 373, the sign verification unit 374 and the using condition verification unit 375. That is, a configuration example of the license server program 37 shown in FIG. 3 indicates a configuration example of the CPU 31 when the license server program 37 is executed.

The content management unit 371 records the content information 500, which is transmitted from the content server 40, in the content information D/B 50 and manages the content information 500.

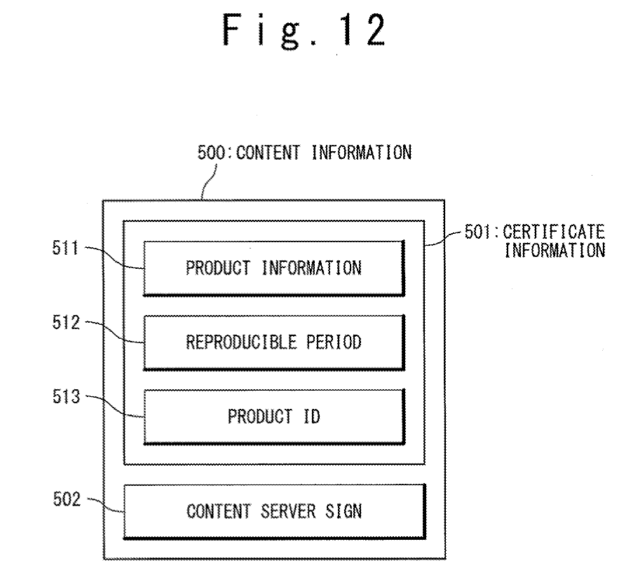

With reference to FIG. 12, the content information 500 includes certificate information 501 for specifying a product provided by the content server 40 and the content server sign 502 provided to the certificate information 501. Here, the product is one or a plurality of pieces of video content data provided by the content server 40.

The certificate information 501 includes product information 511 for specifying respective names and respective resolutions of all of the contents included in the product, respective reproducible periods 512 of all of the contents included in the product, and a product ID 513 specifically provided to the product.

The product information 511 includes, for example, names, identifiers (content IDs), resolutions and obtaining methods (download methods or broadcast channels) of all of the contents included in the product. The download method is, for example, a VoD (Video on Demand) download, a P2P (Peer to Peer) download, or the like.

The reproducible period 512 indicates an expiration date until which the content included in the product can be reproduced by the audio-visual terminal 20 to which the license is assigned. The reproducible period 512 is preferred to include reproducible periods 12 respectively corresponding to all of the contents included in the product. However, the reproducible period 512 may be a reproducible period with respect to the product.

When the user purchases the product, the content management unit 371 records the identifier of the user (the user ID) and the product ID 513 of the product in the content information D/B 50 such that they are correlated with each other.

The license information generation unit 372 generates and issues the license information 600 serving as the electronic certificate for assigning the license, in response to the request from the communication terminal 10.

The license information generation unit 372 generates the license information 600 by setting for the content information 500 corresponding to the product requested by the communication terminal 10, an using condition 601 based on which the communication terminal 10 issues the license, and by providing a license server sign 602 to the content information 500 by using a license server secret key 92.

That is, as shown in FIG. 13, the license information 600 includes the content information 500, the using condition 601 and the license server sign 602.

With reference to FIG. 13, the using condition 601 includes: ticketing condition information 611 in which a condition for validating the license information 600 to generate the ticket 700 is set; reproducing condition information 612 in which a condition for reproducing licensed content is set; and a license ID 613 specifically assigned to the license information 600.

The ticketing condition information 611 includes, for example, information defining an expiration date (ticketing expiration date) until which the communication terminal 10 can generate the ticket 700 and the number of generation of the ticket 700 (the number of ticketing). The reproducing condition information 612 includes information with regard to: the number of reproduction of the content allowed for the audio-visual terminal 20 (the maximum reproduction number); and limitation to the copy of the content. Also, the license server secret key 92 is possessed by only the license server 30.

When generating the license information 600, the license information generation unit 372 registers the license ID, which is assigned to the license information 600, in the license D/B 38. The license ID is preferred to be set at random such that the license ID is different for each piece of license information 600.

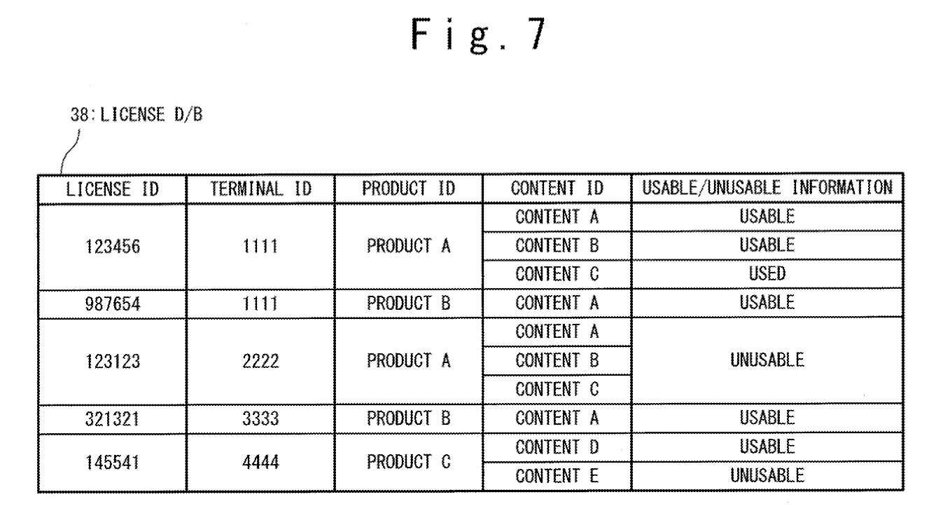

As shown in FIG. 7, the license information generation unit 372 records a license ID 383, a terminal ID of the communication terminal 10 to which the license is assigned, a product ID of a product purchased by the communication terminal 10, a content ID of the content included in the product, and usable/unusable information for controlling usable/unusable of the product (content) in the license D/B 38 such that they are correlated with each other.

Consequently, the communication terminal 10 to which the license is assigned and the product as the target of the license can be managed such that they are correlated with each other. Also, the usable/unusable information is preferred to be provided for respective content ID. Thus, the license server 30 can control the usable/unusable of respective content. Of course, the usable/unusable information may be provided for respective product ID.

Here, the terminal ID is an identifier assigned to the communication terminal 10 that uses the carrier network 100. The terminal ID is preferred to be a serial number which is specific to the terminal and recorded on, for example, a UIM (User Identity Module) card or a SIM (Subscriber Identity Module) card. In this case, since the terminal ID is information that can be known by only the carrier which manages the license server 30, it is difficult that a third party specifies the user using the content.

The group management unit 373 registers a plurality of communication terminals 10 in the group D/B 39 such that the communication terminals 10 are grouped for predetermined categories. For example, the grouping is based on companies which provide contents used by the communication terminals 10 or based on categories corresponding to regions in which the communication terminals 10 are used by users thereof or corresponding to personal information of the users.

The group management unit 373 generates group secret keys 90 (group secret key for sign, 90A and group secret key for encryption, 90B) and group public keys 91 (group public key for sign, 91A and group public key for encryption, 91B) for respective group.

Also, the group management unit 373, in response to a group registration request, transmits the group public keys to the communication terminal 10 and generates partial information for generating the member key 94 and the member certification information 95 specific to the communication terminal 10.

The group D/B 39 records the terminal ID of the communication terminal 10, the group secret key 90, the group public key 91, the member certification information 95 and the terminal public key such that they are correlated with each other. The communication terminal 10 registered in the license D/B 38 can validate the license information issued by the license server 40 and use the validated license information as the electronic certificate (ticket 700).

The sign verification unit 374 verifies the content server sign 502, the license server sign 602 and the group sign 702 which are provided to the ticket 700 by using the content server public key 96, the license server public key 93 and the group public key 91 which are obtained in advance.

The using condition verification unit 375 judges whether or not the ticket 700 is usable by referring to the using condition included in the ticket 700. Here, whether usable or not is judged based on a delivery expiration date of the content as a target of reproduction or an expiration date of the ticket 700, for example.

Also, the using condition verification unit 375 verifies whether or not the ticket 700 is generated based on the license information 600 issued by the license server 30 by referring to the license ID 613 included in the ticket 700. At this time, when the license ID 613 is not recorded in the license D/B 38 or when the usable/unusable information corresponding to the license ID 613 is set to be unusable or already-used, the using condition verification unit 375 inhibits the use of the ticket 700.

Also, the using condition verification unit 375 sets usable/unusable information corresponding to content. IDs included in the already-used tickets 700, to be already-used. At this time, when setting all the contents included in the product to be already used, the using condition verification unit 375 deletes the license IDs corresponding to those tickets 700 from the license D/B 38. At this time, the using condition verification unit 375 may record the change histories of the license IDs in a not-shown archive database.

When the license server 30 is requested to verify the unusable ticket 700, there is a possibility that the ticket 700 is illegally generated or used by mistake. The license server 30 can specify the user who illegally uses or uses by mistake the ticket 700 by using the subscriber information D/B 51 in which subscriber information 102 is recorded for respective communication terminals 10.

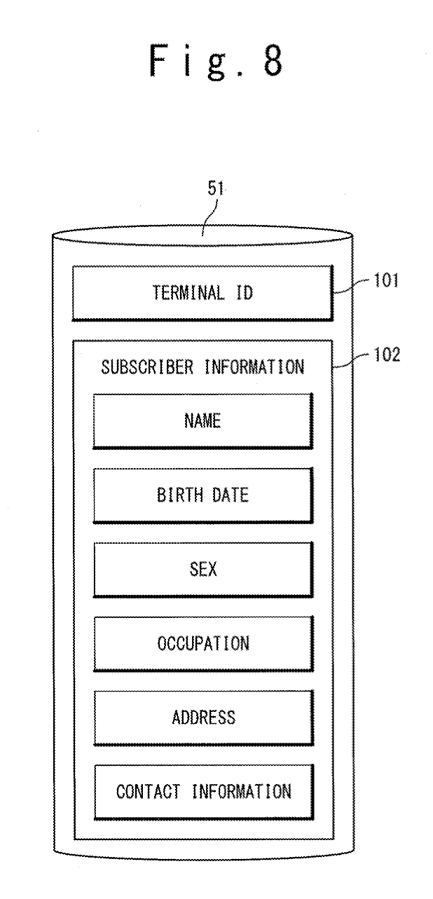

With reference to FIG. 8, the subscriber information D/B 51 includes a terminal ID 101 and the subscriber information 102.

Here, the subscriber information D/B 51 records the subscriber information 102 being correlated with the terminal ID 101. Here, the terminal ID 101 is the terminal ID registered in the SIM card and an identifier specific to the communication terminal 10, which is provided by the carrier. The subscriber information 102 is personal information which is notified to the carrier when the user makes a contract with the carrier with respect to the use of communication. For example, the subscriber information 102 includes a name, a birth date, a sex, an occupation, an address, contact information (telephone number or e-mail address) and the like of the user.

The content server 40 is a computer apparatus capable of being connected through an I/O interface 44 and an I/O interface 45 to the communication line 300 and the communication line 400, respectively.

As shown in FIG. 1, the content server 40 includes a CPU 41, a RAM 42, a storage device 33, the I/O interface 44 and the I/O interface 45. The CPU 41, the RAM 42, the storage device 33, the I/O interface 44 and the I/O interface 45 are connected to each other through a bus. The CPU 41 controls the I/O interface 44 and the I/O interface 45 to control transmission and reception of various data.

The I/O interface 44 controls transmission and reception of data to and from the license server 30 through the communication line 300. The I/O interface 45 controls transmission and reception of data to and from the audio-visual terminal 20 through the communication line 400.

Although not shown, the storage device 43 includes a content database that records video content data as products. Also, the storage device 43 includes a content server program for generating the content information 500 and the encrypted content 800.

The CPU 41 executes the content server program temporarily stored in the RAM 42 to generate the content information 500.

At this time, the content server 40 provides a content server sign 502A to certificate information 501A by using a content server secret key to certify the certificate information.

Also, the content server 40 transmits the content server public key 96 to the communication terminal 10, the audio-visual terminal 20 and the license server 30 by using some method.

The product provided by the content server 40 includes one or a plurality of contents. The information with regard to the product is, notified as the content information 500 to the license server 30.

Also, the CPU 41 executes the content server program to encrypt the content by using the secret key to generate the encrypted content 800, and delivers or broadcasts the encrypted content 800 to the audio-visual terminal 20 to which the license is assigned. Here, the content server 40 transmits the decryption key for decrypting the encrypted content 800 to the audio-visual terminal 20 to which the license is assigned, by using some method.

Based on the above-mentioned configuration, the content using system according to the present invention can realize the following points.

(1) The license server sign 602 certifies the matter and issuer of the license information 600 for providing a right to use the product.
(2) The group sign enables the sign verification of the ticket 700 while ensuring the anonymity of the communication terminal 10 from the audio-visual terminal 20.
(3) Since the communication terminal 10 (terminal ID) as an entity to which an issue is performed is correlated with the license ID of the issued license information 600 in the license server 30, traceability of the ticket 700 can be provided.
(4) The license server 30 can unitarily execute management, selling, verification of illegal use, and prevention of illegal use of products provided by a plurality of content servers 40.
(5) By providing the using condition to the ticket 700, a matter, a reproduction method, and a number of reproduction of content can be set arbitrarily in accordance with a matter of purchased product.

(Operation)

The operations in the exemplary embodiment of the content using system according to the present invention will be described below in detail with reference to the drawings. The communication terminal 10 is required to be group-registered before obtaining the using right (license information 600) of the product from the license server 30.

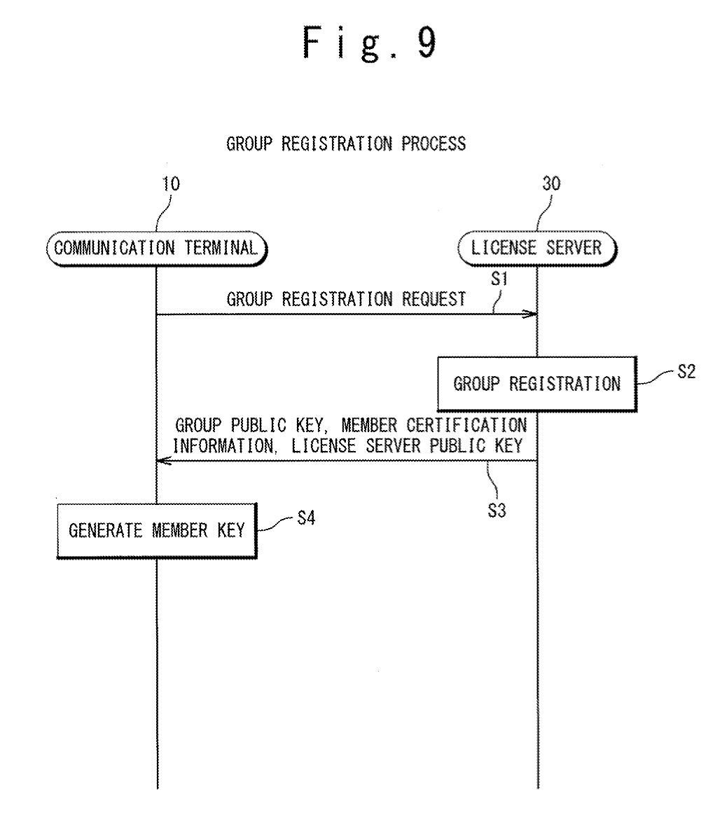

The operation in the group registration of the communication terminal 10 according to the present invention will be described below with reference to FIG. 9.

Here, prior to the group registration process of the communication terminal 10, the license server 30 generates the group secret keys 90 (group secret key for sign, 90A and group secret key for encryption, 90B) and the group public keys 91 (group public key for sign, 91A and group public key for encryption, 91B) for respective group.

(1) Step S1

The communication terminal 10 issues, to the license server 330, a registration request to the group.

(2) Step S2

In response to the group registration request, the license server 30 registers the communication terminal 10 to a group which is set in advance.

Although not shown, when the group registration request is issued from the communication terminal 10, the group management unit 373 of the license server 30 determines the group to which the communication terminal 10 is registered based on information (for example, information with regard to an enterprise to which the communication terminal 10 is desired to be registered) included in the registration request. Then, a group management unit 471 transmits the group public keys 91 of the determined group to the communication terminal 10.

The communication terminal 10 generates a terminal public key, a terminal secret key and sign partial information by using random number and the group public key 91, and transmits the terminal public key and the sign partial information to the license server 30.

The group management unit 373 generates the member certification information 95 specific to the communication terminal 10 by using sign information and the group secret key for sign, 90A. At this time, the group management unit 373 correlates to the group, the terminal ID transmitted by the communication terminal 10 together with the group registration request. In detail, the terminal ID of the communication terminal 10, the member certification information 95, the group (the group secret key 90 and the group public key 91), and the terminal public key which is transmitted by the communication terminal 10 at the time of the group registration are stored in the group D/B 39 such that they are linked to each other.

By the way, at the step S2, the group management unit 373 can register the communication terminal 10 to either the group (group secret key 90, group public key 94) which is newly set in response to the group registration request from the communication terminal 10 or an existing group. Also, the terminal ID transmitted from the communication terminal 10 is identical to the terminal ID recorded in the subscriber information D/B 51.

(3) Step S3

After the completion of the group registration, the license server 30 transmits to the communication terminal 10 the group public key 91, the license server public key 93, the member certification information 95, and the partial information for generating the member key 94. Here, the license server public key 93 may be distributed to the communication terminal 10 in advance.

(4) Step S4

The communication terminal 10 generates the member key 94 specific to the communication terminal 10 by using the member certification information 95, the partial information and the random number generated at the step S1. Here, the license server public key 93 may be distributed to the communication terminal 10 in advance.

On the other hand, the audio-visual terminal 20 obtains the group public key 91 and the license server public key 93 from the communication terminal 10, before receiving the ticket 700. The ticket 700 will be described bellow. Also, the communication terminal 10 and the audio-visual terminal 20 obtain the content server public key 96 by using some method. The content server public key 96 may be directly obtained from the content server 40 or may be obtained through the license server 30. By the way, the audio-visual terminal 20 may obtain the license server public key 93 through the content server 40.

As mentioned above, the communication terminal 10 is registered in the group managed by the license server 30. Therefore, the communication terminal 10 can validate the license information 600 issued by the license server 30 to generate the ticket 700. Also, since obtaining the group public key 91 and the license server public key 93, the communication terminal 10 and the audio-visual terminal 20 can verify the signs of the license information 600 and the ticket 700, respectively.

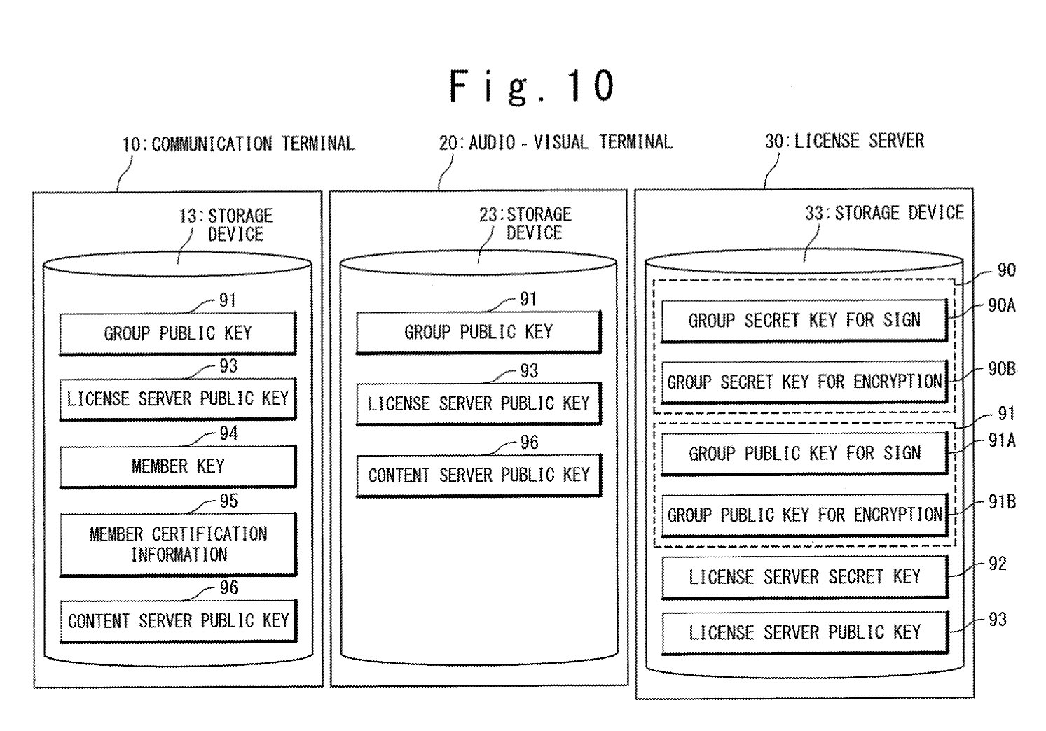

FIG. 10 shows states of holding keys for the respective elements in the content using system according to the present invention. Here, the states of holding keys are shown at the time when the communication terminal 10 is group-registered, generates the ticket 700 and uses the ticket 700.

With reference to FIG. 13, the storage device 13 includes the group public key 91, the member key 94, the license server public key 93 and the member certification information 95. The storage device 23 includes the group public key 91, the license server public key 93 and the content server public key 96. The storage device 33 includes the group secret keys 90, the group public keys 91, the license server secret key 92 and the license server public key 93. By the way, in the storage device 33, the group secret keys 90 include the group secret key for sign, 90A and the group secret key for encryption, 90B. The group public keys 91 include the group public key for sign, 91A and the group public key for encryption, 91B.

Based on the group registration, the communication terminal 10 obtains the group public key 91, the member key 94, the license server public key 93 and the member certification information 95 and stores them in the storage device 13. Also, the communication terminal 10 stores and holds the terminal ID, which is assigned to the communication terminal 10, in the storage device 13 or the not-shown SIM card. The audio-visual terminal 20 obtains the group public key 91, the license server public key 93 and the content server public key 96 and stores them, in the storage device 23. The license server 30 stores the group secret keys 90, the group public keys 91, the license server secret key 92 and the license server public key 93 in the storage device 33.

Although not shown, the license server 30 holds the content public key 96 for verifying the content server sign 502 of the content information 500. Moreover, the license server 30 records the terminal public key of the group-registered communication terminal 10 and the terminal ID specific to the terminal in the group D/B 39 such that they are correlated with each other. Thus, the content server 40 can specify the communication terminal 10 by using the terminal ID.

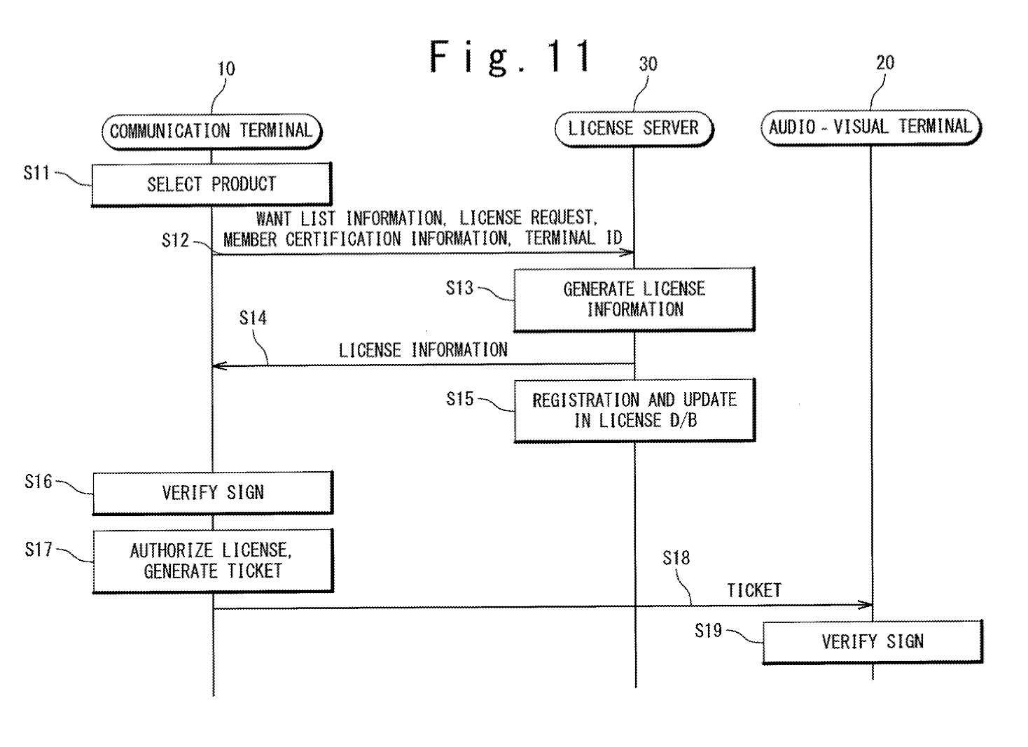

Next, with reference to FIG. 11, the operation in the exemplary embodiment will be described below in detail from the purchase of the product (content) to the issue and reception of the ticket for using the content.

(1) Step S11

The user operates the communication terminal 10 to select the product including the content that is desired to be viewed. At this time, the user, while viewing a menu displayed on a not-shown display screen of the communication terminal 10, operates keys to select the desired product.

(2) Step S12

The communication terminal 10 issues a license request to the license server 30 and transmits want list information specifying the product desired to be purchased and the member certification information 95 to the license server 30.

(3) Step S13

The license server 30 receives the license request and generates the license information 600 corresponding to the product (product ID) specified by the want list information. In detail, at first, the license information generation unit 372 of the license server 30 refers to the member certification information 95 to check whether or not the communication terminal 10 is group-registered.

When the communication terminal 10 is group-registered, the license information generation unit 372 extracts the content information 600 corresponding to the specified product from the content information D/B 50. Then, the license information generation unit 372 provides by using license server secret key 92 the license server sign 602 to information including the content information 500 to which the using condition 601 is added, and thus generates the license information 600.

(4) Step S14

The license server 30 issues the generated license information 600 through the carrier network 100 to the communication terminal 10 as a requester.

(5) Step S15

At this time, the license server 30 registers in the license D/B 38 the license ID 613 assigned to the issued license information 600.

With reference to FIG. 7, the license ID registered in the license D/B 38 is an identifier specifically assigned to the license information 600. Usually, one product ID is assigned to one product. The product includes one or a plurality of contents, and specific content IDs are provided to respective contents in accordance with matters of the contents.

Also, the contents in the product are respectively correlated to pieces of usable/unusable information for respectively controlling whether or not the contents are usable. For example, when communication terminal 10 (of which terminal ID is “1111”) purchases a product (of which product ID is “Product A”) including contents A, B and C, a license ID of “123456” assigned to the license information 600, the terminal ID of “1111” and the product ID of “Product A” are correlated with each other. The product A includes the plurality of contents A, B and C which are respectively correlated with pieces of usable/unusable information. In this case, all of the contents in the product are correlated with the pieces of usable/unusable information. By the way, the number of the contents included in the product may be one (for example, a product B).

Also, a piece of usable/unusable information may be provided per a product in place of being provided per a content. For example, as in the case of a product corresponding to a license ID of “123123”, the product is correlated with a piece of usable/unusable information. Moreover, the number of products that can be purchased by the communication terminal 10 may be plural. The usable/unusable information includes a flag setting content or product, which corresponds to the license information 600, to be usable or unusable, or includes a flag indicating that the content or product is already-used. The sign verification unit 374 or the using condition verification unit 375 sets the flag of the usable/unusable information based on the verification result of the ticket 700.

Also, the carrier may set the flag of the usable/unusable information without depending on the using condition provided to the ticket 700. For example, when the license assigned to the communication terminal 10 is deprived, the usable/unusable information corresponding to the license information 600 as the target of the deprivation is set to be unusable.

By the way, a method may be used which controls the product or contents included in the product not to be used by deleting the license ID or the content ID.

(6) Step S16

When receiving the license information 600, the communication terminal 10 verifies the license server sign 602 by using the license server public key 93. Consequently, it is confirmed that the license information 600 is validly issued by the license server 30.

(7) Step S17

If the sign passes the verification, the communication terminal 10 generates the ticket 700 that functions as an electronic certificate for using the content, based on the license information 600.

Although not shown, the content information 500 and the using condition 601 that are included in the license information 600 are displayed on the display screen of the communication terminal 10. The user checks the using condition of the purchased product and the matters of the contents on the display screen and operates a not-shown input device to select the content desired to be used, the using condition and the like.

The ticket generation unit 173 of the communication terminal 10 provides the group sign 701 to the information (message) by using the member key 94 and the member certification information 95 and the like to generate the ticket 700 as shown in FIG. 14. The information (message) includes the license information 600 to which the information (ticket information 701) with regard to the content as a target of use, which is selected by the user, is added.

At this time, the ticket generation unit 173 may provide the group sign 702 by using random number, the group public key 91, a common variable or the like. The group sign 702 ensures that the ticket 700 is issued by a member of the group registered in the license server 30.

The ticket information 701 set in the ticket 700 includes: information specifying the content that can be used by using the ticket 700 (for example, a content name, an address of an entity which delivers the content, and a resolution); and information specifying the reproducing condition of the content in the audio-visual terminal 20 (for example, reproducible period, number of reproduction and the like) and the download method of the content and the like. Also, the ticket information may include the address of the license server 30 which verities the ticket 700.

(8) Step S18

The communication terminal 10 transmits the generated ticket 700 to the audio-visual terminal 20 in response to the operation of the user. When the ticket 700 is issued, the communication terminal 10 is connected to the audio-visual terminal 20 through the short-range wireless line 200. Because of transmission through the short-range wireless line 200, the user can easily issue the ticket 700 at small communication cost.

By the way, the ticket 700 may be issued through the carrier network 100. When the ticket 700 is issued through the carrier network 100, the ticket can be transmitted to the audio-visual terminal 20 far from the communication terminal 10. In this case, the ticket 700 is preferred to be transmitted through a communication that uses a communication protocol capable of a confidential communication.

Also, the number of generation of the ticket 700 and the timing of generation of the ticket 700 by the communication terminal 10 are limited in accordance with the number of ticketing and a period in which ticketing is possible which are included in the license information 600.

(9) Step S19

When receiving the ticket 700, the audio-visual terminal 20 verifies the content server sign 502 and the license server sign 602 by using the content server public key 96 and the license server public key 93, and verifies the group sign 702 by using the group public key 91. In this way, the audio-visual terminal 20 judges whether or not the ticket 700 is valid electronic money.

At this time, since the group sign 702 is provided to the ticket 700, the audio-visual terminal 20 can verify the ticket 700 without knowing the information with regard to the issuer (communication terminal 10) of the ticket 700. For example, when the audio-visual terminal 20 is installed in a public facility used by the public, since the information with regard to the issuer of the ticket 700 is not disclosed to the audio-visual terminal 20, the leakage of the personal information is prevented.

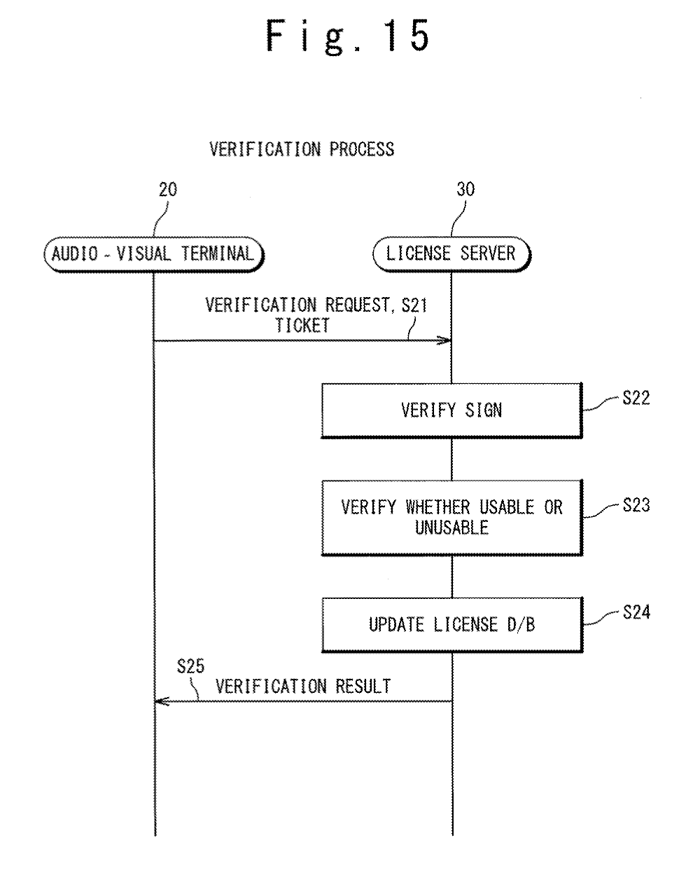

Next, the verifying process of the ticket 700 will be described with reference to FIG. 15.

When obtaining the ticket 700, the audio-visual terminal 20 can verify whether or not the ticket 700 is usable at an arbitrary timing. Prior to the verification, the audio-visual terminal 20 is connected through the communication line 900 to the license server 30. Here, the audio-visual terminal 20 specifies the license server 30 by using the address of the license server included in the ticket information 701.

(1) Step S21

The audio-visual terminal 20 transmits the ticket 700 together with a verification request to the license server 30. At this time, the audio-visual terminal 20 transmits own terminal ID together with the verification request to the license server 30.

(2) Step S22

In response to the verification request, the sign verification unit 374 of the license server 30 verifies the content server sign 502 and the license server sign 602 by using the content server public key 96 and the license server public key 93, and verities the group sign 702 by using the latest group public key 91.

(3) Step S23

When the ticket 700 is a valid electronic certificate based on the license information 600, the using condition verification unit 375 verifies whether or not the ticket 700 is usable.

At the step S23, the verification of usable or unusable based on the license ID and the verification of usable or unusable based on the using condition are carried out. The using condition verification unit 375 checks whether or not a certificate ID equal to a certificate ID 513 included in the ticket 700 is registered in the license D/B 38. At this time, when the certificate ID equal to the license ID 613 of the ticket 700 is registered in the license D/B 38, the using condition verification unit 375 judges that it passes. When the certificate ID equal to the license ID 613 of the ticket 700 is not registered in the license D/B 38, the using condition verification unit 375 judges that it does not pass.

Also, the using condition verification unit 375, by referring to the ticket information 701 included in the ticket 700, specifies the use target content and judges whether or not the content is usable.

The using condition verification unit 375, by referring to the license D/B 38, judges whether or not the content is usable based on the license ID 613 of the ticket 700 and the usable/unusable information corresponding to the content ID of the use target content. At this time, when the unusable flag or the already-used flag is set in the usable/unusable information, the using condition verification unit 375 judges that the content is unusable.

Moreover, the using condition verification unit 375, by referring to the reproducible period 512 in the certificate information 501, judges whether or not the content is usable based on whether or not a current time is within the reproducible period 512.

(4) Step S24

After the completion of the verifying process, the license server 30 updates the usable/unusable information corresponding to the license ID of the verified ticket 700 (for respective content ID). In detail, when the ticket 700 is judged to be usable in the verification process, the license server 30 sets the already-used flag in the usable/unusable information of the content ID (product ID) corresponding to the ticket 700. Also, the license server 30 may correlate the terminal ID of the audio-visual terminal 20 to the license ID and the content ID which have become usable.

Consequently, the license server 30 can manage the audio-visual terminal 20 to which the license of the content is assigned. In this case, the license server 30 obtains the terminal ID of the audio-visual terminal 20 at the step S21. When the ticket is judged to be unusable in the verification process, the license server 30 sets the unusable flag in the usable/unusable information of the content ID (product ID) corresponding to the ticket 700.

As mentioned above, the license server 30 can determine to assign or not to assign the license to the audio-visual terminal based on the verification with respect to whether or not the ticket 700 is usable.

Also, since the license D/B 38 records the terminal ID of the communication terminal 10 and license ID such that they are correlated with each other, the license server 30 can specify the communication the communication terminal 10 which has issued the unusable ticket 700.

Moreover, even when the license ID 613 of the ticket 700 is not registered in the license D/B 38, the license server 30 can specify the communication terminal 10 as a issuer of the ticket 700. In detail, the license server 30 extracts from the ticket 700 the terminal secret key of the communication terminal 10 which has provided the group sign 702A by using the group secret key for encryption, 90B. The license server 30 manages the terminal public key and the information (the terminal ID 101 and the subscriber information 102) specifying the communication terminal 10 such that they are correlated with each other. Thus, the carrier which possesses the license server 30 can know the terminal that illegally issues the ticket 700 or transmits the ticket 700 by mistake.

(5) Step S25

After verifying whether the ticket 700 is usable or not, the license server 30 notifies the audio-visual terminal 20 of the verification result in which the ticket 700 is determined to be usable or unusable.

The verifying process from the step S21 to the step S25 enables the audio-visual terminal 20 to which the license is assigned by the license server 30 to reproduce the content set in the ticket information 701 of the ticket 700. At this time, the audio-visual terminal 20 determines the matter, the resolution, and the download method of the content to be reproduced based on the ticket information 701 set in the ticket 700.

Also, the audio-visual terminal 20 sets the reproducible period of the content and the maximum number of reproduction of the content based on the reproducing condition information 612. The obtaining and reproducing methods of the content are preferred to be methods based on a DRM technique.

The audio-visual terminal 20 to which the license is assigned obtains by using some method the decryption key with which the encrypted content 800 corresponding to the ticket 700 can be decrypted. Then, the audio-visual terminal 20 decrypts the encrypted content 800 delivered by the content server 40 by using the decryption key to reproduce the content.

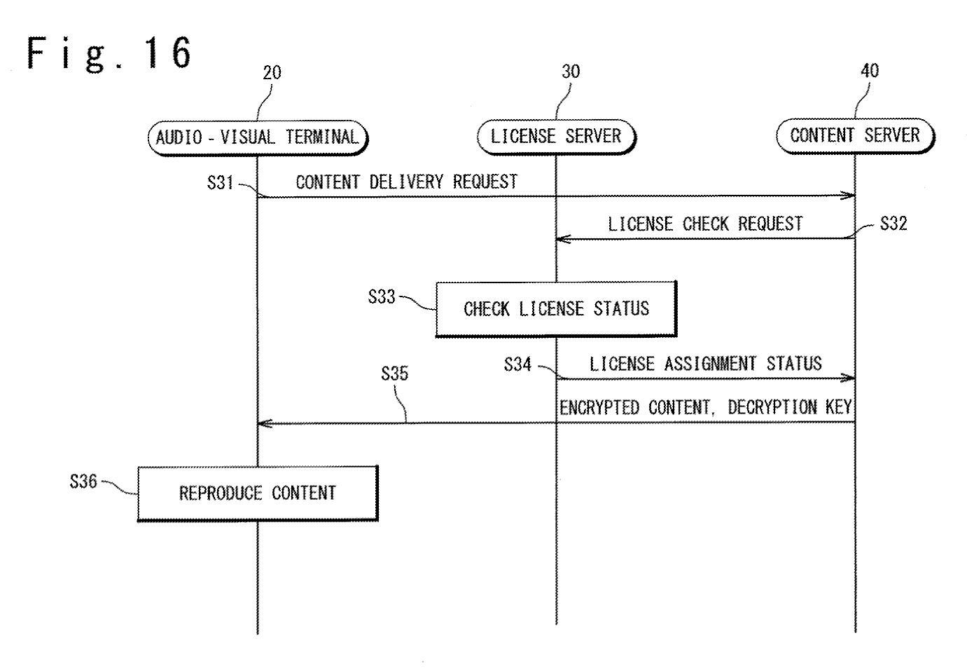

The methods of obtaining the decryption key from the content server 40 and reproducing the content will be described below with reference to FIG. 16.

(1) Step S31

The audio-visual terminal 20 to which the license is assigned issues a content delivery request, which specifies the content ID included in the ticket information 701, to the content server 40. At this time, the audio-visual terminal 20 transmits information (terminal ID or address) for specifying the audio-visual terminal 20 to the content server 40.

(2) Step S32

The content server 40 issues to the license server 30 a license check request which specifies the terminal ID of the audio-visual terminal 20 and the content ID.

(3) Step S33

The license server 30 judges whether or not the specified audio-visual terminal 20 has the license of the specified content by referring to the license D/B 38.

When the content ID specified by the content server 40 is correlated with the terminal ID of the audio-visual terminal 20 and the content ID, the license server 30 judges that the license is assigned to the audio-visual terminal 20. On the other hand, when the terminal ID of the audio-visual terminal 20 is not correlated, the license server 30 judges that the license is not assigned to the audio-visual terminal 20.

Preferably, the information registered in the license D/B 38 is deleted when the expiration date set for respective license information 600 lapses and its change history is recorded in the not-shown archive database. The expiration date is preferred to be equal to the end of the reproducible period set in the reproducing condition information 612. Consequently, when a status of assignment of the license is checked after the elapse of the expiration date, it is judged that the license is not assigned.

(4) Step S34

The license server 30 notifies the content server 40 of the status of assignment of the license, which is checked at the step S33. However, when the license server 40 notifies the content server 40 of the audio-visual terminal 20 to which the license is assigned, the content usable based on the license, the expiration date of the license and the like after whether or not the ticket 700 is usable is verified at the step 23, the steps S32 to S34 are omitted.

(5) Step S35

The content server 40 makes sure that the license is assigned to the audio-visual terminal 20 based on the notified status of assignment of the license and transmits the encrypted content 800 generated by encrypting the required content and the decryption key to the audio-visual terminal 20. When the license is not assigned to the audio-visual terminal 20, the content server 40 does not transmit at least the decryption key.

(6) Step S36

The audio-visual terminal 20 decrypts the obtained encrypted content 800 by using the decryption key to reproduce the content. At this time, the content can be reproduced for the number of reproduction and during the reproducible period which are set by the reproducing condition information 612.

When the DRM technique is used as the reproduction protocol for the content, the content server 40 uses the terminal information (for example, the terminal ID) specific to the audio-visual terminal 20, which is transmitted by the audio-visual terminal 20 at the step S31 or by the license server 30 at the step S34, to generate the decryption key. When the terminal information possessed by the audio-visual terminal 20 agrees with terminal information in the decryption key, the audio-visual terminal 20 can decrypt the encrypted content 800 by using the decryption key to reproduce the content.

The method by which the audio-visual terminal 20, to which the license is assigned, obtains the decryption key is not limited to the above-described method. The audio-visual terminal 20 may obtain the decryption key by issuing a request for the decryption key to the license server 30 which obtains the decryption key from the content server 40 in advance.

Also, the audio-visual terminal 20 may record the content (encrypted content 800) by downloading it or may record the content (encrypted content 800) that is stream delivered or broadcasted. Also, the content may be delivered in response to a request from the audio-visual terminal 20 or may be delivered at a predetermined timing or periodically.

As mentioned above, according to the content using system according to the present invention, the control of sales and using rights of the products (contents) provided by a plurality of companies can be unitarily managed by one carrier. The product (content) provided by the content server 40 is a pay product, a free product or a product which can be changed with points issued by a company. In a case of the pay product, a fee of the product is preferred to be dealt with similarly to a communication fee when the carrier network 100 is used. That is, the product fee is preferred to be collected together with the communication fee by the carrier.

Consequently, the payments of the fees can be made unitary, and subscribers (clients) of the carrier can be converted to users of the content. Also, points corresponding to the product fee are preferred to be added to points issued by the carrier. In this case, since a variety of the points collected by the users are not wide, an eagerness to buy the content is enhanced.

The communication terminal 10 to which the using right of the content is assigned can issue the ticket 700 to which various reproducing conditions of the content are provided. At this time, the group sign enables the certification of the matter of the ticket 700 while concealing the information of the issuer of the ticket 700 from the audio-visual terminal 20. Also, only the terminal group-registered in the license server 30 can provide the group sign. Thus, only the license server 30 can trace the communication terminal 10 which issues the ticket 700.

The license server 30 can generate an issuing history of the ticket 700 from the matter which is recorded in the license D/B 38 at the verification of whether or not the ticket 700 is usable. Also, the license server 30 can know who views which content based on the issuing history and the subscriber information D/B 50. That is, the license server 3 can obtain information with respect to a market research of the content. The carrier can obtain a new income by selling the information to the provider of the content.

Also, the license server 30 can cancel the license assigned to the communication terminal 10 by controlling the license D/B 38 (by deleting the license ID or by changing the usable/unusable information). For example, the license server 30 can cancel the license in response to a request for cancelling the license from the communication terminal 10. Also, the license server 30 can extend the term of the license, add a license and change the license by providing new license information 600 in response to a request from the communication terminal 10.

Moreover, in a case that the communication terminal 10 set an issued time of the ticket in the ticket information 701, the license server 30 can know the issued time of the ticket at the verification of the ticket 700. Also, the content information 500 may include image data or program for displaying information (for example, a sample image or sample video) with respect to the content. The content information 500 may records a URL of a cite (for example, a download page of the content) providing information with respect to the content or a hash value of a matter of that.

As mentioned above, the exemplary embodiment of the present invention has been described in detail. However, the concrete configuration is not limited to the above-mentioned exemplary embodiment. The configuration with modifications within the range of the scope of the present invention is included in the present invention.

The exemplary embodiment is described with regard to the case in which the ticket 700 includes the reproducing condition information 612 such as the number of reproduction of the content, the reproducible period of the content and the like. However, the ticket 700 may includes the reproducing condition information 612 as well as a condition (a number of copying and a period in which copying is allowed) for the audio-visual terminal 20 to copy the content, or the like.

Also, the management server secret key 92 may be equal to the group secret key for sign, 90A, and the management server public key 93 may be equal to the group secret key for encryption, 90B. In this case, a labor for managing the keys and a labor for verifying the electronic certificate can be partially omitted.

Moreover, the communication terminal 10 may copy the ticket 700 and transmit copies of the ticket 700 to a plurality of audio-visual terminals 20. In this case, among the plurality of audio-visual terminals 20, only the audio-visual terminal 20 performing the first verification of the ticket 700 in the license server 30 can use the ticket 700.

For example, when the user having the communication terminal 10 views the content on one of the audio-visual terminals 20 respectively placed in a plurality of rooms in a house of the user, the transmission of the ticket 700 to every audio-visual terminal 20 enables that the user does not required to view the content on a specific audio-visual terminal 20 but the user can view the content on an audio-visual terminal 20 in a desired room. In this case, the tickets 700 stored in the audio-visual terminals 20 other than the audio-visual terminal 20 which has used the content are not authenticated by the license server 30, and thus cannot be used.

As mentioned above, the present invention has been described by referring to the exemplary embodiment. However, the present invention is not limited to the above-mentioned exemplary embodiment. The configuration and details of the present invention can be modified within a scope of the present invention by performing various modifications which can be understood by those skilled in the art.

1. A content using system comprising:
a license management unit;
a communication unit; and
an audio-visual unit,
wherein said license management unit transmits license information including a using condition of content to said communication unit,
said communication terminal issues an electronic ticket including said license information to which a group sign is provided,
said audio-visual terminal, after verifying said group sign of said electronic ticket obtained from said communication unit, transmits said electronic ticket to said license management unit,
said license management unit judges based on said using condition whether or not said electronic ticket is usable after verifying said group sign of said electronic ticket transmitted form said audio-visual unit and assigns a license of said content to said audio-visual unit when said electronic ticket is judged to be usable, and
said audio-visual unit decrypts said content which is encrypted, by using a decryption key obtained based on said license and reproduces said content.

2. The content using system according to claim 1, wherein said license management unit registers a group and said communication unit in a group database such that said group and said communication terminal are correlated with each other,
said communication unit obtains a member key and member certification information specific to said communication unit when said communication unit is registered in said group database,
said member certification information is generated by using a group public key,
said communication unit generates said group sign by using said member key and said member certification information, and
said audio-visual unit verifies said group sign by using said group public key.

3. The content using system according to claim 2, wherein said license management unit stores information with regard to a user of said communication unit and an identification ID of said communication unit in a subscriber information database such that said information with regard to said user and said identification ID are correlated with each other, and
said license management unit stores said identification ID and said group in said group database such that said identification ID and said group are correlated with each other.

4. The content using system according to claim 2, wherein said electronic ticket includes:
said license information;
ticket information including information specifying content which can be used based on said electronic ticket; and
said group sign provided to said license information and said ticket information.

5. The content using system according to claim 1, wherein said license management unit registers in a license database a license ID assigned to said license information, and
said license management unit limits an assignment of said license to said audio-visual unit when said license database does not register a license ID included in said electronic ticket transmitted from said audio-visual unit.

6. The content using system according to claim 1, wherein said license information includes:
content information including information with regard to one or a plurality of contents included in a product;
said using condition; and
a digital sign which is provided to said content information and said using condition based on a secret key for license management possessed by only said license management unit, and
said using condition includes:
a reproducing condition of said content for said audio-visual unit; and
an issuing condition of said electronic ticket for said communication unit.

7. The content using system according to claim 6, wherein said content information includes reproducible periods of said one or a plurality of contents included in said product, and
said license management unit refers to said reproducible periods included in said electronic ticket transmitted from said audio-visual unit to judge whether or not said electronic ticket is usable.

8. The content using system according to claim 6, wherein said issuing condition include information indicating a period in which said communication unit can issue said electronic ticket based on said license information.

9. The content using system according to claim 6, wherein said issuing condition include information indicating a number of times at which said communication unit can issue said electronic ticket based on said license information.

10. The content using system according to claim 6, wherein said reproducing condition include information a number of times at which said audio-visual terminal can reproduce content based on said electronic ticket.

11. A license server used as said license management unit in the content using system according to claim 1.

12. A communication terminal used as said communication unit in the content using system according to claim 1.

13. An audio-visual terminal used as said audio-visual unit in the content using system according to claim 1.

14. A content using method comprising:
issuing license information including a using condition of content;
issuing an electronic ticket including said license information to which a group sign is provided;
judging based on said using condition whether or not said electronic ticket is usable after verifying said group sign of said electronic ticket;
assigning a license of said content to a viewer when said electronic ticket is judged to be usable; and
decrypting said content which is encrypted by using a decryption key obtained based on said license, to reproduce said content.

15. The content using method according to claim 14, further comprising:
registering another party of communication in a group;
obtaining a member key and member certification information specific to said another party of communication when said another party of communication is registered in said group, wherein said member certification information is generated by using a group public key;
generating said group sign by using said member key and said member certification information; and
verifying said group sign by using said group public key.

16. The content using method according to claim 15, further comprising:
storing information with respect to a user of said another party of communication and an identification ID of said another party of communication in a subscriber information database such that said information with respect to said user and said identification ID are correlated with each other; and
storing said identification ID and said group in a group database such that said identification ID and said group are correlated with each other.

17. The content using method according to claim 15, further comprising:
specifying content, which can be used based on said electronic ticket, as ticket information;
generating a group sign for said license information and said ticket information; and
generating an electronic ticket which includes said license information, said ticket information and said group sign.

18. The content using method according to claim 14, further comprising:
generating said license information;
registering in a license database a license ID assigned to said license information;
verifying whether a license ID included in said electronic ticket is registered in said license database; and
limiting an assignment of said license to said viewer when said license ID included in said electronic ticket is not registered in said license database.
